(19) United States
(12) Patent Application Publication
(10) Pub. No.: US 2007/0268476 A1
(43) Pub. Date: Nov. 22, 2007

(54) KINEMATIC CHUCKS FOR RETICLES AND OTHER PLANAR BODIES

(75) Inventors: Alton H. Phillips, East Palo Alto, CA (US); Douglas C. Watson, Campbell, CA (US); W. Thomas Novak, Hillsborough, CA (US)

Correspondence Address: KLARQUIST SPARKMAN, LLP, 121 SW SALMON STREET, SUITE 1600, PORTLAND, OR, 97204, US

(73) Assignee: Nikon Corporation

(21) Appl. No.: 11/749,706

(22) Filed: May 16, 2007

Related U.S. Application Data
(60) Provisional application No. 60/801,866, filed on May 19, 2006.

(51) Int. Cl. G03B 27/62

(52) U.S. Cl. 355/75; 355/72

(57) ABSTRACT

Devices are disclosed for holding and moving a planar body such as a reticle as used, for example, in microlithography. An exemplary device includes a stage and a body chuck. The stage has a movable support surface. A proximal region of a first membrane is mounted to the support surface. A distal region of the first membrane extends from the support surface and is coupled to the chuck such that the first membrane at least partially supports the chuck. The chuck includes a surface from which multiple pins extend. The surface is situated at the distal region. The pins are arrayed to contact and support a respective region of the body. The pin arrangement is configured such that, during movements of the chuck imparted by the support surface, body slippage relative to the pins due to forces caused by the movement is substantially uniform at each pin.

### CROSS REFERENCE TO RELATED APPLICATION

This application claims priority from, and the benefit of, U.S. Provisional Application No. 60/801,866, filed on May 19, 2006, which is incorporated herein by reference in its entirety.

### FIELD

This disclosure pertains to, inter alia, microlithography, which is a key imaging technology used in the manufacture of semiconductor micro-devices, displays, and other products having fine structure that can be fabricated by processes that include microlithographic imprinting. More specifically, the disclosure pertains to devices for holding a reticle or other planar body.

### BACKGROUND

In a typical projection microlithography system, the pattern to be projected onto the surface of an exposure-sensitive substrate is defined by a “reticle,” sometimes called a “mask.” In the microlithography system the reticle is mounted on a stage that is capable of undergoing fine and highly accurate movements as required during the lithographic exposure. While mounted on the reticle stage, the reticle is illuminated by a radiation beam (e.g., a beam of deep-ultraviolet or vacuum-ultraviolet light). As the beam propagates downstream from the reticle, the beam carries an aerial image of the illuminated pattern. This downstream beam, called a “patterned beam” or “imaging beam,” passes through a projection-optical system that conditions and shapes the patterned beam as required to form a focused image of the pattern on the surface of an exposure-sensitive lithographic substrate (e.g., a resist-coated semiconductor wafer). For exposure, the substrate also is mounted on a respective movable stage called a “substrate stage” or “wafer stage.”

For holding the reticle (usually horizontally) during the making of lithographic exposures, the reticle stage is equipped with a “reticle chuck” mounted to a moving surface of the reticle stage. The reticle chuck holds the reticle in a suitable manner for imaging while avoiding damage to the delicate reticle. For example, some reticle chucks hold the reticle by applying a vacuum force to the reticle. Other reticle chucks hold the reticle by electrostatic or Lorentz-force attraction. In microlithography systems in which the radiation beam is transmitted through the reticle, the reticle chuck is usually configured to hold (to “chuck”) the reticle around the periphery (or at least along two opposing sides) of the reticle, thereby leaving the patterned regions of the reticle unsupported. Due to the mass of the reticle, the unsupported middle region of the reticle tends to sag due to gravity. The sag deforms the reticle and can degrade the imaging performance of the microlithography system if not corrected or compensated for in some manner.

Two important measures of performance of a microlithography system are overlay and image quality. Image quality encompasses any of various parameters such as image resolution, fidelity, sharpness, contrast, and the like. “Overlay” pertains to the accuracy and precision with which a current image is placed relative to a target location for the image. For example, proper overlay requires that the image be in registration with a previously formed, underlying structure on the substrate.

The deformed shape of a chucked reticle has a direct impact on overlay and image quality. If reticle sag is inevitable, then the ideal deformed shape is at most second-order (parabolic) about the scanning axis (y-axis). Making appropriate adjustments to downstream optics (e.g., the projection-optical system) can compensate for this kind of reticle deformation, but each reticle usually deforms differently from another reticle, and it is impractical to adjust the downstream optics each time a different reticle is chucked.

With a chucked reticle, localized frictional forces are established at regions of contact of the reticle with the chuck, and these frictional forces are key to retaining position of the reticle on the chuck during movements of the reticle stage. But, these frictional forces may not be sufficient to overcome localized shear stresses between the reticle and chuck during accelerations and decelerations of the reticle stage. These shear stresses can cause slip of the reticle relative to the chuck. Also, after an acceleration or deceleration the reticle and chuck may not, as a result of reticle slip, return to their original respective shapes and positions relative to each other. In such an event residual stresses will be produced in the reticle and chuck, which may cause adverse reticle distortions during scanning motions of the reticle stage during lithographic exposure. Another consequence of reticle slip is a non-repeatable change in the relative position between the reticle and interferometers that are used for determining reticle position. This change directly affects overlay accuracy.

These issues conventionally have been addressed by attempts to control and minimize thermal and mechanical distortion over the entire reticle stage. However, as successive generations of microlithography systems require increasingly higher stage accelerations, and as overlay specifications continue to tighten, the limitations of this approach have become more apparent.

One approach for solving this problem is discussed in U.S. Pat. No. 6,956,222 to Gilissen et al., in which the reticle rests on a “pimple plate” extending over a table with a gap between the pimple plate and the table. The pimple plate is made of a very rigid material (glass or ceramic) and comprises multiple bumps that contact the reticle. The reticle is held on the pimple plate by electrostatic attraction. The pimple plate is held on the membranes by electrostatic attraction. The underside of the pimple plate is supported by support pins mounted to the table. The pimples have high stiffness in all three (x, y, z) directions. Unfortunately, during accelerations and decelerations of the reticle stage holding a reticle, the reticle exhibits an unacceptable amount of slip relative to the pimple plate, and the pimple plate exhibits an unacceptable amount of slip relative to the membranes.

Another approach for solving this problem is discussed in U.S. Pat. No. 6,480,260 to Donders et at., incorporated herein by reference. According to the '260 patent, two opposing side (flanking) regions (relative to the y-direction, the scanning direction) of the reticle are held on the reticle stage with the aid of respective “compliant members” arranged parallel to each other. In a preferred embodiment, each compliant member has a strip-like configuration that extends lengthwise along the respective side region of the reticle and along the respective side region of the reticle stage. One lateral side region of the compliant member is mounted to the respective side region of the reticle stage and the other lateral side region of the compliant member extends in a cantilever manner from the respective edge region of the reticle stage. Extending along the full length of the cantilevered side region of each compliant member and projecting upward are short walls that encircle and define a respective “vacuum space.” The walls and vacuum space collectively define respective reticle “chucks.” The corresponding under-side of the reticle actually rests on the top edges (“lands”) of the walls that collectively serve as respective “chuck surfaces.” Evacuating the vacuum space holds the reticle on the chuck surfaces. Whereas the compliant members exhibit compliance in the z-direction and yield somewhat to the shape of the reticle, they nevertheless have high stiffness in the x-y directions, as do the walls. At least three pins extend between the underside of the chucks and the top surface of the reticle stage (i.e., two pins beneath one chuck and one pin beneath the other chuck). Also, one or more “pins” can be located in the vacuum spaces to provide additional support for the chucked regions of the reticle; these configurations are called “pin chucks.” During accelerations and decelerations of the reticle stage supporting a reticle chucked in this manner, the reticle still exhibits an unacceptable amount of slip relative to the chuck surfaces.

### SUMMARY

In view of the foregoing summary of conventional reticle chucks, it would be advantageous if the reticle could be chucked on the reticle stage with further reduced (or completely eliminated) slip of the reticle relative to the chuck surfaces, while still providing kinematic support for the reticle. Achieving such a goal would eliminate a substantial source of overlay errors and the like during lithographic exposures.

According to a first aspect, devices are provided for holding and moving a planar body, such as a reticle. An embodiment of the device comprises a stage and a body chuck. The stage has a movable support surface. The device includes a first membrane including a proximal region and a distal region. The proximal region is coupled to the support surface. The distal region extends from the support surface and is coupled to the body chuck such that the first membrane at least partially supports the body chuck. The body chuck comprises a surface and multiple pins. The surface is situated at the distal region of the first membrane. The pins extend relative to the surface and are arrayed on the surface to contact and support a respective portion of the body relative to the surface. The pins are arrayed so that, during movements of the body chuck imparted by corresponding movement of the support surface, slippage of the body relative to the pins due to forces caused by the movement is substantially uniform at each pin.

In certain embodiments of the device summarized above, the stage has first and second support surfaces spaced apart from each other (but that desirably move in a synchronous manner). The body chuck comprises a first chuck portion and a second chuck portion, and the first membrane comprises a first membrane portion mounted to and extending from the first support surface and a second membrane portion mounted to and extending from the second support surface. The first chuck portion is mounted to a distal region of the first membrane portion, and the second chuck portion is mounted to a distal region of the second membrane portion.

The body chuck can comprise at least one vacuum chuck, such as for a reticle. In this and other configurations, the body chuck can comprise walls extending from the surface. The walls desirably define, in cooperation with the surface and a portion of the body contacting the body chuck, a vacuum cavity.

The pins optionally can include side pins located in the vacuum cavity and associated with the walls. The free-standing pins are situated in the vacuum cavity and extend from the surface.

The walls have respective lands, and the pins have respective top surfaces. The top surfaces (and optionally at least one of the lands) collectively define a chuck surface that contacts and at least partially supports the body whenever the body is being held by the device. The top surfaces of the pins (and optionally at least one of the lands) contact an under-surface of the body. The walls can be integral with the surface. At least one of the walls can be made of a different material than the surface and mounted to the surface.

The pins can be arranged to extend in at least one longitudinal column in a scanning direction of the body chuck as moved by the support surface. The pins can be arranged at substantially identical pitch in the at least one column. The pins can be arranged in multiple longitudinal columns. In this latter configuration each column can have a respective pin-pitch, and the respective pin-pitches can be substantially identical. Alternatively, each column has a respective pin-pitch, wherein the respective pin-pitches of at least two columns are different. The columns can be substantially equally spaced from each other or differently spaced from each other. The pins can be shaped identically or differently. For example, the pins can have respective shapes such as, but not limited to, cylindrical, spherical, rectangular, elliptical, oval, square, other polygonal, frustoconical, stepped, and combinations thereof. The pins can have substantially identical respective stiffness or variable stiffness.

The device can include a second membrane that can comprise the surface from which the pins extend. The second membrane can have a substantially uniform thickness or have a variable thickness. The second membrane can be made of a material such as, but not limited to, fused silica, calcium fluoride, magnesium fluoride, barium fluoride, cordierite (magnesium aluminum silicate), aluminum oxide, invar, ZERODUR®, or stainless steel. The pins can be integral with, and made of the same material as, the second membrane.

In embodiments including a second membrane, at least one of the walls can be made of the same material as the second membrane. Alternatively, at least one of the walls can be made of a different material than the second membrane and be attached to the second membrane. For example, the at least one wall can be made of a material such as, but not limited to, PTFE or low-durometer, chemically clean rubber.

According to another aspect, devices are provided for holding and moving a reticle. An embodiment of such a device comprises a stage comprising first and second movable support surfaces. The device also comprises a reticle chuck mounted to the support surfaces. The reticle chuck comprises first and second chuck portions. Each chuck portion comprises a respective first membrane having a respective first region and a respective second region. The first regions are mounted to the respective first and second support surfaces such that the second regions extend toward each other from the first and second support surfaces. The first and second chuck portions are mounted to the respective second regions. Each chuck portion comprises a respective surface (which can be of a second membrane mounted to the first membrane or part of the first membrane) and respective walls and free-standing pins extending from the surface. The surface and respective walls collectively define a respective vacuum cavity whenever a respective region of a reticle is situated on the chuck portion. The walls provide respective lands that can be contacting or non-contacting lands, wherein a contacting land contacts the under-surface of the reticle and a non-contacting land does not. At least the pins (and optionally at least one land) contact and support the respective region of the reticle. The pins are configured and arranged so that, during a movement of the reticle chuck by the stage, slippage of the reticle relative to the pins (and any contacting lands) due to shear forces caused by the movement occurs with substantial uniformity at each pin and contacting land.

Alternative embodiments concern various configurations of pins, pin columns, walls, lands, vacuum cavities, etc., as summarized above. In certain embodiments the tops of the pins (and any contacting lands) in each chuck portion collectively define respective chuck surfaces situated in a plane and configured to hold respective portions of the reticle.

According to yet another aspect, process systems are provided. Various embodiments of such a system comprise a process device and a device, such as any of the devices summarized above, for holding and moving a planar body relative to the process device. The process device can be, for example, an optical system.

According to yet another aspect, microlithography systems are provided. Various embodiments of such a system comprise an imaging optical system configured to imprint a pattern, defined on a reticle, on a lithographic substrate. The embodiments also comprise a reticle stage situated relative to the imaging optical system and comprising a movable support surface. A reticle chuck is mounted to the support surface and comprises at least one chuck portion such as any of the configurations summarized above.

The foregoing and additional features and advantages of the invention will be more readily apparent from the following detailed description, which proceeds with reference to the accompanying drawings.

### BRIEF DESCRIPTION OF THE DRAWINGS

FIG. 1(A) is a plan view of a first representative embodiment of a kinematic reticle chuck, as an exemplary device for holding and moving a planar body.

FIG. 1(B) is an elevational section along the line B-B in FIG. 1(A).

FIG. 1(C) is an oblique view of a region in the vicinity of the section shown in FIG. 1(B).

FIG. 2 is a schematic diagram depicting certain stiffness variables, in which Kₛₚ is side-pin stiffness, K_{wl} is long-web stiffness, K_{ws} is short-web stiffness, K_{cp} is central-pin stiffness, and Kₘ is membrane stiffness.

FIG. 3 depicts the y-force distribution, at 20×g acceleration, among central pins and side pins of a kinematic reticle chuck according to an example (Example 1) of the first representative embodiment; force numbers are per pin.

FIG. 4 depicts various exemplary shapes of pins.

FIG. 5 depicts a second-order deformation of the reticle as chucked, exhibiting a parabolic profile about the scanning axis (y-axis).

FIG. 6 obliquely depicts pin and land displacement as experienced by Example 1 under 20×g acceleration.

FIG. 7(A) is a plan view of a second representative embodiment of a kinematic reticle chuck, as another exemplary device for holding and moving a planar body.

FIG. 7(B) is an elevational section along the line B-B in FIG. 7(A).

FIG. 7(C) is an oblique view of a region in the vicinity of the section shown in FIG. 7(B).

FIG. 8 is an elevational section of a vacuum chuck according to a third representative embodiment.

FIG. 9 is a schematic diagram of the analytical model of Example 2.

FIG. 10(A) schematically depicts pin shear.

FIG. 10(B) schematically depicts pin bending under a force load.

FIG. 10(C) schematically depicts pin bending under a moment load.

FIG. 10(D) schematically depicts pin pivoting.

FIG. 11 includes plots of y-force and of displacement of pins and web in Example 2.

FIG. 12(A) is a schematic elevational view of a portion of a kinematic reticle chuck according to a fourth representative embodiment, in which the pins are not all the same length.

FIG. 12(B) is a schematic elevational view of a portion of an alternative configuration of the kinematic reticle chuck shown in FIG. 12(A).

FIG. 13 is a schematic elevational view of a portion of a kinematic reticle chuck according to a fifth representative embodiment.

FIG. 14 is an elevational schematic diagram showing certain aspects of an exposure system that includes a kinematic reticle chuck as disclosed herein.

FIG. 15 is a block diagram of an exemplary semiconductor-device fabrication process that includes wafer-processing steps including a lithography step.

FIG. 16 is a block diagram of a wafer-processing process as referred to in FIG. 15.

### DETAILED DESCRIPTION

The following description is set forth in the context of representative embodiments that are not intended to be limiting in any way.

In the following description, certain terms may be used such as “up,” “down,” “upper,” “lower,” “horizontal,” “vertical,” “left,” “right,” and the like. These terms are used, where applicable, to provide some clarity of description when dealing with relative relationships. But, these terms are not intended to imply absolute relationships, positions, and/or orientations. For example, with respect to an object, an “upper” surface can become a “lower” surface simply by turning the object over. Nevertheless, it is still the same object.

In this disclosure, the term “reticle” is used to denote a pattern-defining object (pattern master) used in microlithography and related techniques. Another term frequently used in microlithography to denote the pattern master is “mask,” and it will be understood that “reticle” as used herein encompasses masks and other pattern masters used in microlithography.

From Applicants' detailed studies and evaluations of conventional reticle chucks, the following were discovered or confirmed:

(1) Reticle slip occurs whenever the shear stress (denoted Sₛ) between the reticle and chuck surface exceeds the product of the contact stress (denoted S_{c}) and the coefficient of friction (denoted u) between the reticle and chuck: Sₛ>S_{c}·u.

(2) Reticle slip is minimized whenever the ratio (denoted R) of the product of the contact stress and the coefficient of friction to shear stress is maximized: R=S_{c}·w/Sₛ.

(3) The shear stress is proportional to the product of the relative displacement (denoted dy) between the reticle stage and reticle and the stiffness (denoted K) between the reticle and stage: Sₛ≈K·dy.

(4) In the case of a pin chuck, the contact stress at a pin top is proportional to the product of the chuck vacuum pressure (denoted P) and the unsupported area (denoted A) around the pin: S_{c}≈P·A.

As a result of the foregoing, it was deemed desirable to maximize R for each contact of the chuck with the reticle. By maximizing R for each contact, R will be substantially equal for each contact. I.e., the system will be optimized or balanced whenever the onset of slip occurs at every contact of the reticle chuck and the reticle at the same time.

### FIRST REPRESENTATIVE EMBODIMENT

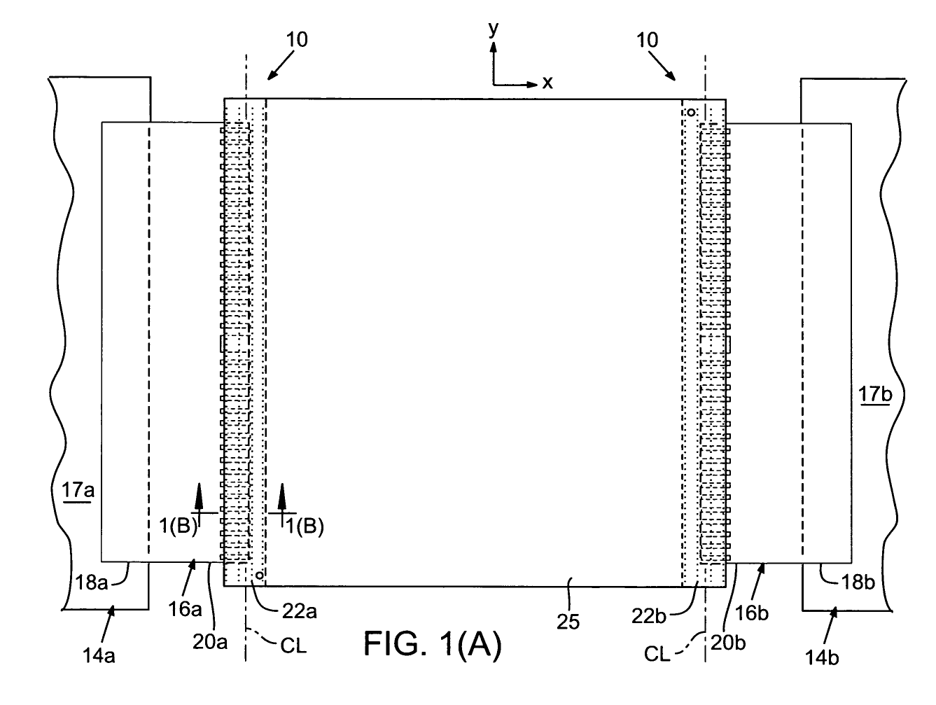

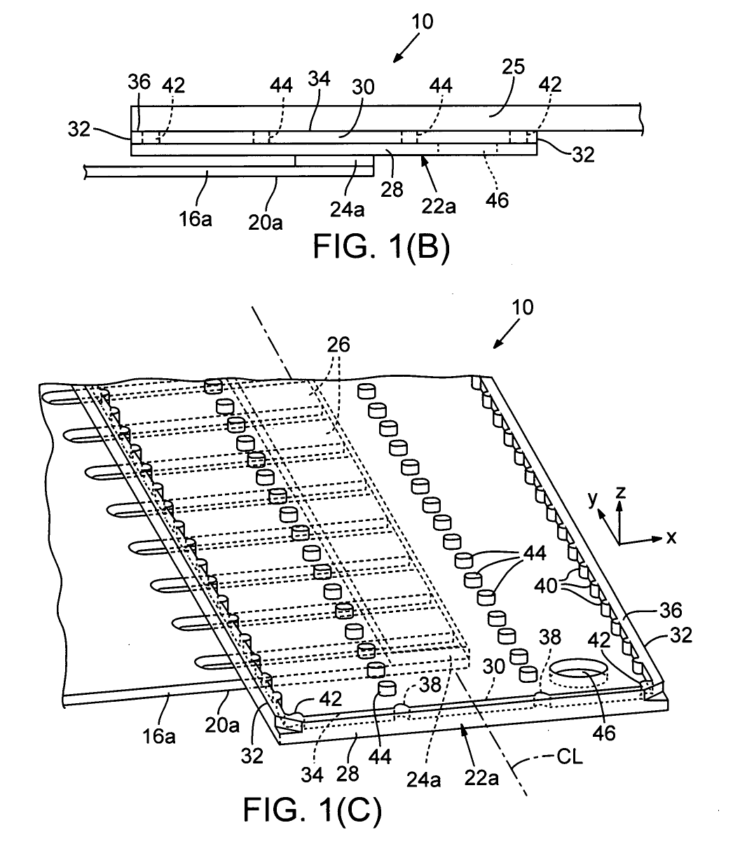

A first representative embodiment of a kinematic reticle chuck 10 is depicted in FIGS. 1(A)-1(C). FIG. 1(A) is a plan view of the x-y plane, wherein the y-direction is the scanning direction. Shown are left and right portions 14a, 14b of the reticle stage 12, each presenting a respective support surface 17a, 17b. The portions 14a, 14b extend parallel to each other in the y-direction and oppose each other in the x-direction. Attached to the support surfaces 17a, 17b are respective flexible members (each termed a “first membrane” herein) 16a, 16b. Each first membrane 16a, 16b has a first lateral region 18a, 18b attached to the respective support surface 17a, 17b of the reticle stage 12, and a second lateral region 20a, 20b extending in a cantilever manner from the respective portion 14a, 14b. Hence, the first lateral regions 18a, 18b are respective “proximal” regions (relative to the support surfaces 17a, 17b, respectively) of the first membranes 16a, 16b, and the second lateral regions 20a, 20b are respective “distal” regions (relative to the support surfaces 17a, 17b, respectively) of the first membranes 16a, 16b. Mounted to the upward-facing surface of each second lateral region 20a, 20b is a respective vacuum chuck 22a, 22b. The vacuum chucks 22a, 22b have respective center lines CL extending in the y-direction. The vacuum chucks 22a, 22b support a reticle 25.

As shown in FIG. 1(B) the vacuum chucks 22a, 22b are attached along their respective center lines CL to the second lateral regions 20a, 20b of the first membranes 16a, 16b. Between each vacuum chuck 22a, 22b and the respective second lateral region 20a, 20b is a respective spacer 24a, 24b serving to elevate the vacuum chucks (in the z-direction) slightly from the upper surfaces of the respective second lateral regions. The spacers 24a, 24b facilitate mounting the vacuum chucks 22a, 22b along their respective center lines to the second lateral regions 20a, 20b.

As an alternative to using a separate spacer 24a, 24b, the spacers can be integral with the vacuum chucks 22a, 22b. For example, the lower surface of each vacuum chuck 22a, 22b can be thicker (in the z-direction) in the region occupied by the respective spacer in the depicted embodiment.

Further details of the second lateral region 20a and its respective vacuum chuck 22a are shown in FIG. 1(C), in which the reticle is not shown so as to reveal underlying detail, In the depicted embodiment, the second lateral region 20a comprises multiple tines 26 extending parallel to each other in the x-direction. (In other embodiments, as described later below, the tines 26 are omitted.) The spacer 24a is mounted at the ends of the tines 26, and the vacuum chuck 22a is mounted to the upper surface of the spacer 24a. The vacuum chuck 22a comprises a base (also called a “second membrane” or “web”) 28 from which walls 30, 32 project in the z-direction.

The walls 30, 32 have respective upper surfaces 34, 36, called “lands.” (Although the figure shows all the lands at a uniform height above the surface of the second membrane 28, this is not intended to be limiting; in other embodiments discussed later below, the lands are of unequal height above the second membrane.) In this embodiment, at least one lateral wall 30 defines respective “side pins” 38, and, optionally, at least one longitudinal wall 32 defines respective side pins 40. (In other embodiments, as described later below, the side pins 38, 40 are omitted, since they are optional.) The side pins 38 in the depicted embodiment project upward from the upper surface of the second membrane 28 the same height as the walls 30, 32. This embodiment also includes optional corner pins 42 located at the intersections of the walls 30, 32, and multiple (two are shown) longitudinal columns of free-standing pins 44 extending upward from the second membrane 28.

The lands 34, 36 and pins 38, 40, 44 of this embodiment all have substantially the same height above the second membrane 28 and collectively define a “chuck surface,” extending in the x-y direction, on which the reticle is placed (FIG. 1(B)). The reticle 25, second membrane 28, and walls 30, 32 collectively define a vacuum cavity 33 that is evacuated through a port 46 that extends through the second membrane 28. Reducing the pressure in the vacuum cavity 33 urges the reticle against the lands 34, 36 and pins 38, 40, 44.

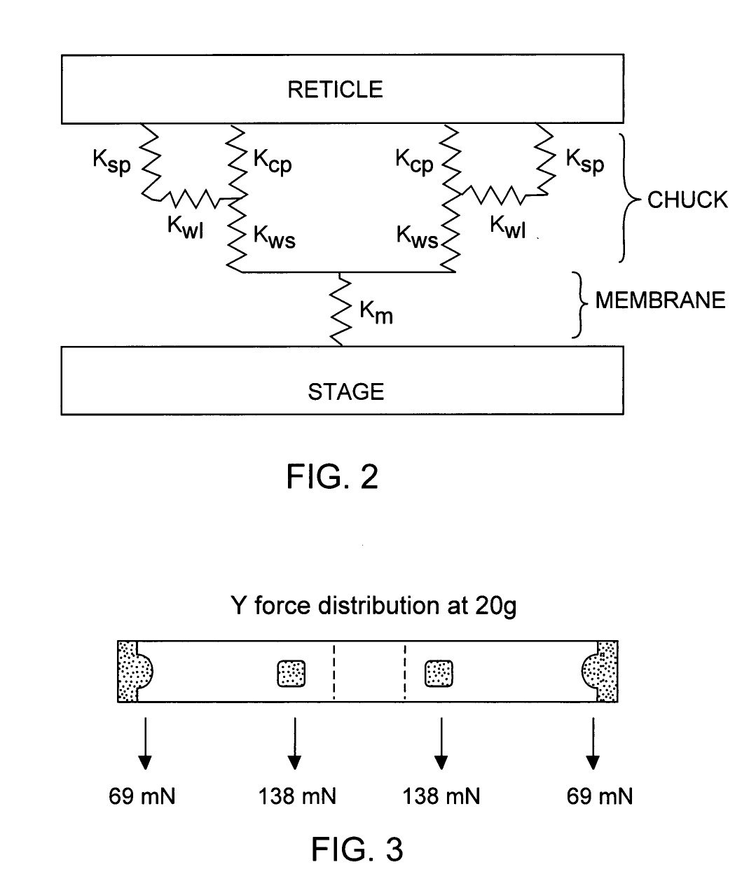

The contact pressure (S_{c}) on the side pins 38, 40 desirably is substantially half the contact pressure on the free-standing pins 44 (if the pins are equally spaced from each other):
S_{c}=S_{csp}=(½)S_{cp}
wherein S_{csp} is the shear stress at a side pin 38, 40, and S_{cp} is shear stress at a free-standing pin 44. To achieve balance and optimization, the respective stiffnesses of the free-standing pins 44, the side pins 38, 40 (if present), and the intervening web structure desirably are established such that the stiffness path from the reticle stage 14a, 14b to the reticle 25 through the side pins is substantially half the stiffness path through the free-standing pins:
1/K=2(1/Kₛₚ+1/K_{wl}+1/K_{ws}+1/Kₘ)=(1/K_{cp}+1/K_{ws}+1/Kₘ)
wherein K denotes overall stiffness, Kₛₚ denotes side-pin stiffness, K_{wl} denotes stiffness of the second membrane (web) in the long dimension, K_{ws} denotes stiffness of the second membrane (web) in the short dimension, K_{cp} denotes stiffness of a free-standing pin, and Kₘ denotes stiffness of the first membrane. A diagram of these variables is shown in FIG. 2. This expression assumes that the coefficient of friction is the same at each pin.

By way of example, the mass of a typical reticle is 0.3 kg, which generates a shear force of 66 N at an acceleration of 20×g. Two chucks, each having two longitudinal columns of free-standing pins (80 pins per column) according to the foregoing, produce a distribution of y-direction force as shown in FIG. 3, in which the lands and side pins experience a y-direction force of 69 mN per pin, and the free-standing pins experience a y-direction force of 138 mN per pin. In FIG. 3 the dashed lines indicate the position of the spacer 24.

The free-standing pins 44 serve important roles, notably providing a balanced stiffness to first-membrane attachment. In this regard, multiple columns (in the y-direction) of free-standing pins 44 are desirable. Again, see the exemplary force distribution shown in FIG. 3. It is noted that the bending flexibility of the second membrane (web) around the base of the free-standing pins 44 affects the “tilting” stiffness of these pins.

This embodiment solves a key problem that is experienced by conventional reticle chucks, namely the problem of slippage due to unequal shear forces at each point of contact of the vacuum chucks with the reticle. In this embodiment, if the reticle 25 were subject to an acceleration or deceleration having a magnitude sufficient to cause the reticle to slip on the vacuum chucks 22a, 22b, the slippage point (magnitude of shear stress) is substantially the same at each such point of contact of the reticle with the vacuum chucks.

Exemplary materials from which to fabricate the first membranes 16a, 16b and second membranes 28, 28b are fused silica (amorphous quartz), calcium fluoride, magnesium fluoride, barium fluoride, cordierite (magnesium aluminum silicate), aluminum oxide, invar, and ZERODUR® (a brand of glass ceramic from Schott AG, Germany). For less demanding applications, any of several metals alternatively could be used, such as a stainless steel. Particularly desirable materials have extremely low coefficients of thermal expansion, and the foregoing list is similar to a list of candidate materials for fabricating reticles. The reticle chucks can be made of any of these materials, and can be made of the same material as the first membranes or of a different material.

The walls 30, 32 and lands 34, 36 need not be made of the same material as the second membrane 28. For example, as described later below, the lands can be made of PTFE (TEFLON®, DuPont) or low-durometer, chemically clean rubber (e.g., OPTIC ARMOR™) attached adhesively to the second membrane 28.

The walls 30, 32 in this embodiment have respective lands 34, 36 that are all in the same x-y plane (as the tops of the pins), which is achieved in this embodiment by configuring all the walls 30, 32 with identical height relative to the upper surface of the second membrane 28. But, having all the lands in the same x-y plane in this embodiment is not intended to be limiting. In alternative embodiments, such as described later below, at least one of the walls (e.g., the outboard wall) is shorter than other of the walls (e.g., the inboard wall), thereby placing the land of the shorter wall below the x-y plane of the pin tops and leaving a gap between the land and the underside of the reticle. Shorter walls typically would not include side pins.

The walls 30, 32 in this embodiment are continuous with each other, but this is not intended to be limiting; the walls alternatively can be discontinuous (e.g., separated from each other at the corners and/or having gaps in them in the x- or y-direction). Vacuum chucks having at least one shorter wall or a wall with at least one gap along its length form “leaky” seals for the vacuum cavity 33.

Evacuating the cavity 33 in each vacuum chuck 22a, 22b generates a force, normal to the x-y plane of the reticle 25, serving to urge the reticle against the lands 34, 36, and tops of the pins 38, 40, 44. Among their various functions, the free-standing pins 40 also prevent local collapse of the reticle 25 toward the second membranes 28.

In the embodiment discussed above, each vacuum chuck 22a, 22b is a single respective unit. In alternative embodiments, each vacuum chuck 22a, 22b can comprise multiple units, such as pairs of units, the latter providing more than one vacuum chuck per side of the reticle 25.

In the embodiment described above, the second lateral regions 20a, 20b of the first membranes 16a, 16b have many tines 26. In certain alternative embodiments, fewer tines 26 are present; in other alternative embodiments, the second lateral regions 20a, 20b lack tines. In embodiments that include tines, the space between each tine can be different from what is shown in FIG. 1(A), and need not be uniform.

The first lateral regions 18a, 18b of the first membranes 16a, 16b can be attached to their respective support surfaces 17a, 17b of the reticle stage by any of various suitable means. Exemplary means includes screws or bolts, clips, adhesive, or other suitable means.

In the embodiment described above, each vacuum chuck 22a, 22b comprised multiple columns of free-standing pins 44 (two columns are shown). In certain alternative embodiments each vacuum chuck has only one column of free-standing pins 44, which may be adequate if the lands 34, 36 have the same height as the free-standing pins and/or if the vacuum chucks include side pins 38, 40. In other alternative embodiments (several described later below), each vacuum chuck has more than two columns of free-standing pins. Also, the number of free-standing pins 44 per column is not limited to the specific number (e.g., 80) that would be implied by FIG. 1(C). Individual or several columns can have different respective pitches of pins (in the y-direction) than other column(s), and in any column the y-direction pitch need not be uniform. Also, the space (x-direction pitch) between adjacent columns need not be equal from column to column. In addition, the free-standing pins 44 need not be located over the spacers 24a, 24b or only over the spacers. Furthermore, although the free-standing pins 44 are arranged in symmetrical columns in this embodiment, this is not intended to be limiting. In other embodiments, for example, the x-direction distance from the wall 38 to its nearest row of free-standing pins 44 may be less than the x-direction distance from the wall 36 to its nearest row of free-standing pins 44.

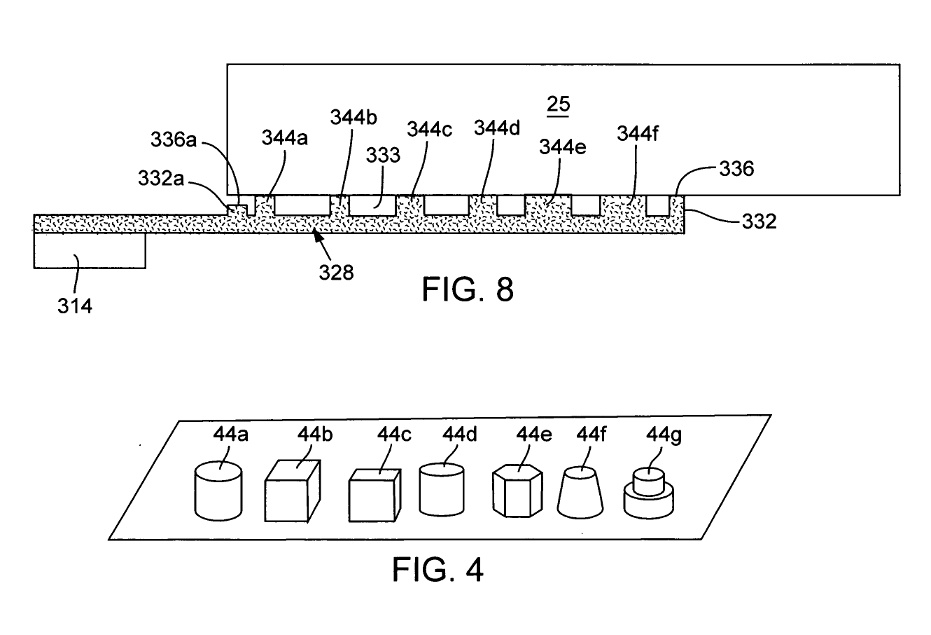

Although the free-standing pins 44 are depicted in this embodiment as having a cylindrical shape, this is not intended to be limiting. Alternative pin shapes include, but are not limited to, rectangular, elliptical, oval, square, other polygonal (e.g., hexagonal), frustoconical, stepped, etc. These exemplary shapes are shown in FIG. 4, including cylindrical 44a, square 44b, rectangular 44c, elliptical 44d, hexagonal 44e, frustoconical 44f, and stepped 44g.

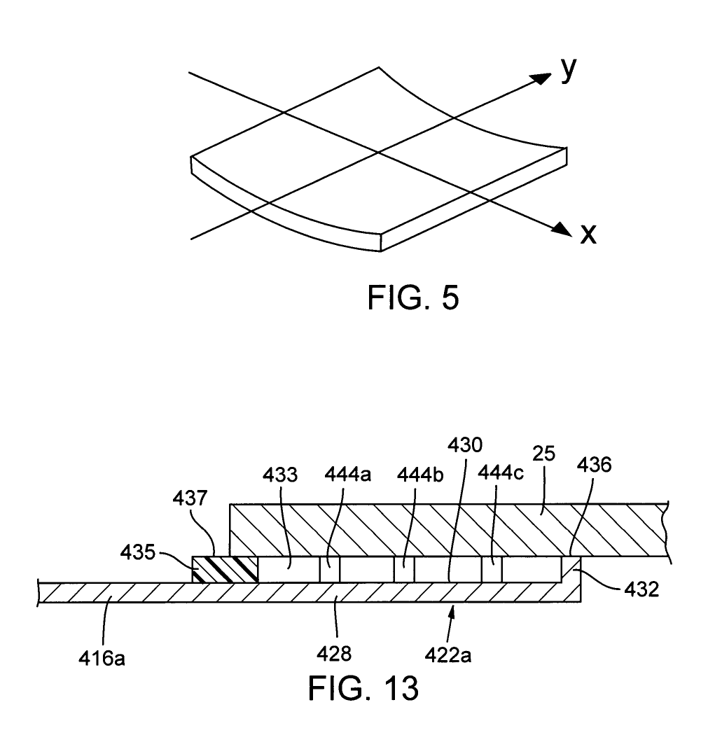

A reticle placed on a reticle chuck according to this embodiment likely will experience gravity-induced sag, which is largely inevitable with an object supported in this manner. See FIG. 5, which depicts an ideal deformed-reticle shape. The “ideal” deformed shape is one that is, at most, second-order about the scanning axis (y-axis). As already discussed, two important measures of performance of a microlithography system are overlay and imaging. The deformed shape of a chucked reticle has a direct impact on overlay and imaging. But, if the deformed shape is, at most, second-order (parabolic) about the scanning axis, then downstream optics can be readily adjusted to compensate the effects of the deformation. This embodiment achieves this goal. In addition, although different reticles have different respective flatness, this embodiment of a reticle chuck kinematically supports the reticle so that differing reticle flatness does not affect the deformed shape when the reticle is chucked. Also, this embodiment holds the reticle securely even as the reticle stage undergoes repeated accelerations and decelerations in the y-direction. Thus, overlay errors are minimized.

In an alternative embodiment, the spacers 24a, 24b and second membranes 28 are omitted, and the respective upper surfaces of the second lateral regions 20a, 20b of the first membranes 16a, 16b provide a surface from which the respective walls and pins extend.

### EXAMPLE 1

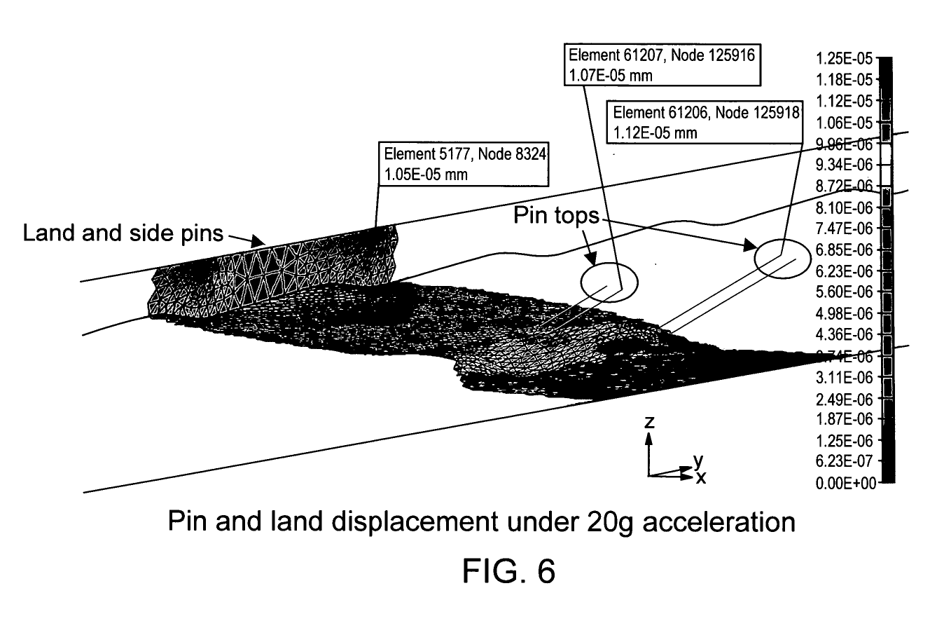

FIG. 6 depicts, in an oblique view, relative displacements of pins and land of this embodiment as experienced during 20×g acceleration. Note that the land, side pins, and free-standing pins have substantially equal displacement for the y-force distribution shown in FIG. 3.

### SECOND REPRESENTATIVE EMBODIMENT

The first representative embodiment comprised free-standing pins 44 and side pins 38, 40 that were all of the same height as the lands 34, 36. The first embodiment also included tines 26. The second representative embodiment comprises no tines and no side pins. Also, the outboard lands are shorter than the free-standing pins and inboard lands. Thus, the outboard lands are not in the same x-y plane as the tops of the free-standing pins and inboard lands.

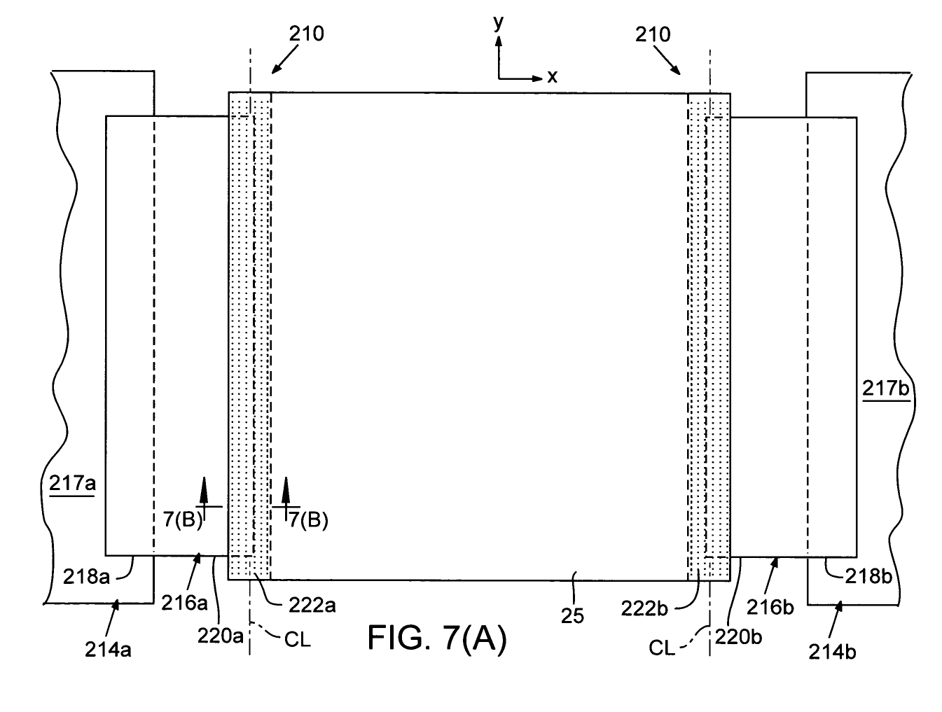

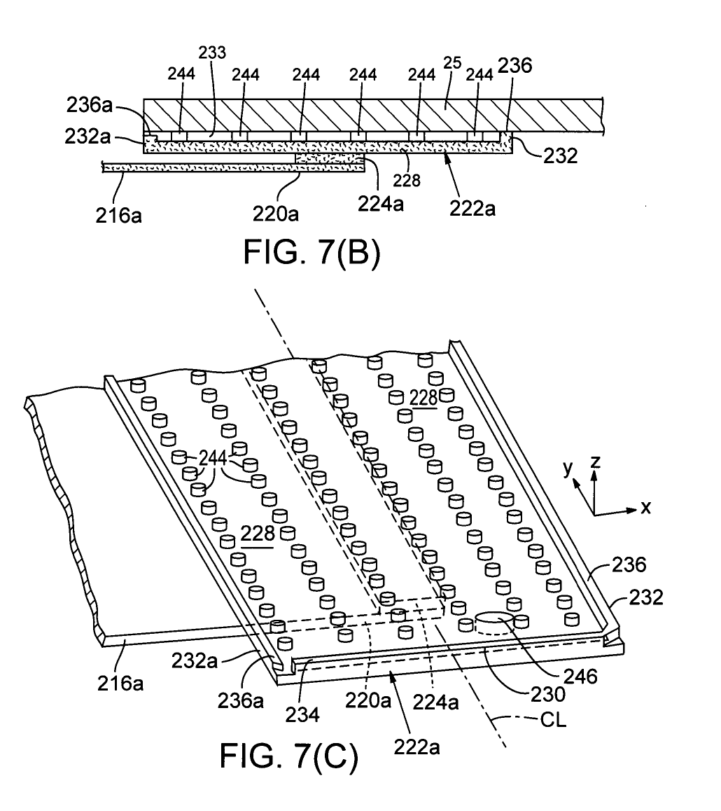

FIGS. 7(A)-7(C) depict a reticle chuck 210 according to this embodiment. FIG. 7(A) is a plan view of the x-y plane, wherein the y-direction is the scanning direction. Shown are left and right portions 214a, 214b of the reticle stage 212, each presenting a respective support surface 217a, 217b. The portions 214a, 214b extend parallel to each other in the y-direction and oppose each other in the x-direction. Attached to the support surfaces 217a, 217b are respective flexible members (“first membranes”) 216a, 216b. Each first membrane 216a, 216b has a first lateral region 218a, 218b attached to the respective support surface 217a, 217b, and a second lateral region 220a, 220b extending in a cantilever manner from the respective portion 214a, 214b. Mounted to the upward-facing surface of each second lateral region 220a, 220b is a respective vacuum chuck 222a, 222b. The vacuum chucks 222a, 222b have respective center lines CL extending in the y-direction. The vacuum chucks 222a, 222b support a reticle 225.

As shown in FIG. 7(B), the vacuum chucks 222a, 222b are attached along their respective center lines CL to the second lateral regions 220a, 220b of the first membranes 216a, 216b. Between each vacuum chuck 222a, 222b and the respective second lateral region 220a, 220b is a respective spacer 224a, 224b serving to elevate the vacuum chucks (in the z-direction) slightly from the upper surfaces of the respective second lateral regions. The spacers 224a, 224b facilitate mounting the vacuum chucks 222a, 222b along their respective center lines to the second lateral regions 220a, 220b.

Further details of the second lateral region 220a and its respective vacuum chuck 222a are shown in FIG. 7(C), in which the reticle is not shown so as to reveal underlying detail. Note that, in contrast to the first representative embodiment, the second lateral regions 220a, 220b lack tines in this second embodiment. The spacer 224a is mounted on the second lateral region 220a, and the vacuum chuck 222a is mounted to the upper surface of the spacer 224a. The vacuum chuck 222a comprises a “second membrane” or “web” 228 from which walls 230, 232, 232a project in the z-direction. The walls 230, 232, 232a have respective lands 234, 236, 236a. The outboard land 236a of the wall 232a is shorter in the z-direction than the land 234 or the inboard land 236. Note also that this embodiment lacks side pins and lacks corner pins. This embodiment does include multiple (six are shown) longitudinal columns of free-standing pins 44 extending upward from the second membrane 228. The lands 234, 236 and free-standing pins 244 of this embodiment all have substantially the same height above the second membrane 228 and collectively define a chuck surface (extending in a respective x-y plane) on which the reticle 25 is placed (FIG. 7(B)). The reticle 25, second membrane 228, and walls 230, 232, 232a collectively define a vacuum cavity 233 that is evacuated through a port 246 that extends through the second membrane 228. Reducing the pressure in the vacuum cavity 233 urges the reticle 25 against the lands 234, 236 and pins 244.

As in the first representative embodiment, although the free-standing pins 244 are depicted in this embodiment as having a cylindrical shape, this is not intended to be limiting. Alternative pin shapes include, but are not limited to, rectangular, elliptical, oval, square, hexagonal, frustoconical, stepped, etc., as shown in FIG. 4, discussed above.

In the depicted embodiment (FIGS. 7(A)-7(B)) the membranes 216a, 228a are arranged in a non-symmetrical manner with the land 232 contacting the reticle 25 and the land 232a not contacting the reticle. In other words, in this configuration the land 232 is a “contacting land” and the land 232a is a “non-contacting land.” In an alternative embodiment, the land 232a (in addition to the land 232) is a contacting land. In another alternative embodiment both lands 232, 232a are non-contacting lands. Furthermore, the side lands 234 can be either contacting or non-contacting.

### THIRD REPRESENTATIVE EMBODIMENT

In the second representative embodiment, all the free-standing pins have substantially identical thickness in the x-y direction. In the instant embodiment, as shown in FIG. 8 (providing a view from the same viewpoint as FIG. 7(B)), the free-standing pins 344a-344f are arranged in six respective longitudinal columns. The pins in each column have a different diameter than the pins in other columns. The pins 344a-344f extend upward (in the z-direction) from the membrane (web) 328.

Note that, in this embodiment, there are not two “membranes” such as the first membrane 216 and second membrane 228 in the second representative embodiment. Rather, in this embodiment, there is only the membrane 328, one along each opposing side of the reticle 25.

Also, in this embodiment, the inboard land 336 (of the wall 332) is the same height as of the pins 344a-344f; hence, the inboard land 336 is a contacting land because it contacts the underside of the reticle 25. The outboard land 336a (of the wall 332a), in contrast, is shorter than the pins 344a-344f and hence is a non-contacting land because it does not contact the underside of the reticle 25. A vacuum is applied to the cavity 333 to hold the reticle 25 on the pins 344a-344f and inboard land 336. Also shown is a base 314 to which the membrane 328 is attached.

This and other embodiments described herein indicate that the lands optionally may have respective heights that are shorter than the free-standing pins, at least in certain locations. At the locations in which the lands have shorter height, the reticle is not in contact with the lands. There is no reticle slippage at these locations since there is no reticle contact at these locations.

### EXAMPLE 2

In this example, referring again to FIG. 8, the pins 344a-344f have respective diameters of 0.11 mm, 0.15 mm, 0.16 mm, 0.19 mm, 0.25 mm, and 0.38 mm. The height of the contacting land 336 and of the pins 344a-344f from the upper surface of the membrane 328 is 0.1 mm; the width of the lands 336, 336a (in the x-direction) is 0.2 mm; the thickness of the membrane 328 (in the z-direction) is 0.45 mm, the number of pins per column is seventy-eight, the pin-pitch (center to center) in the x-direction is 1.75 mm; and the pin-pitch (center to center) in the y-direction is 1.5 mm.

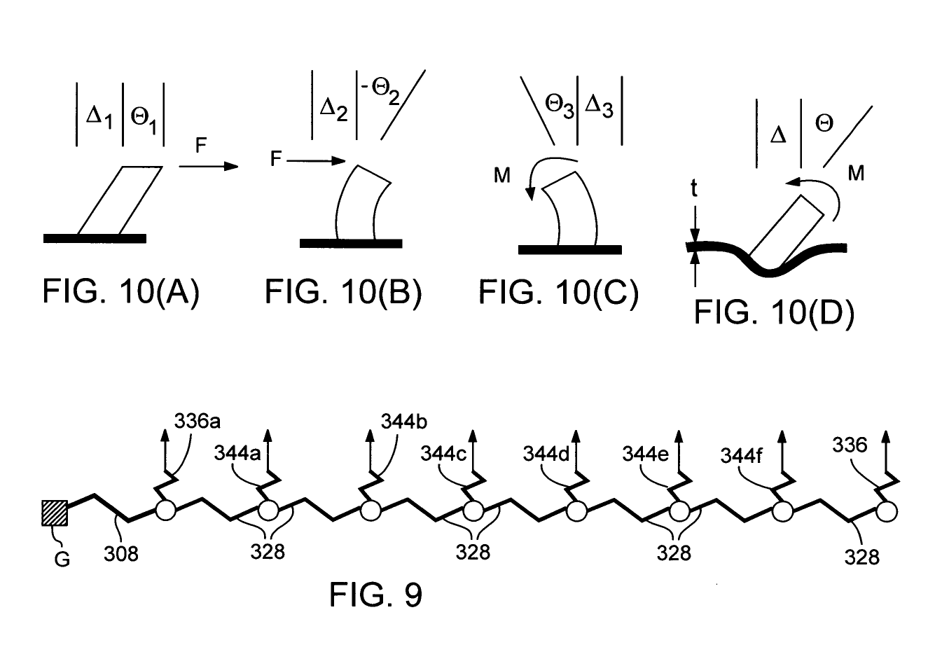

An analytical model of this example is shown in FIG. 9, depicting the non-contacting land 336a, the contacting land 336, pins 344a-344f, membrane (web) 328, and ground G. The upward arrows denote y-direction forces at the respective free-standing pins and lands, and the circles denote respective nodes. A rigid element 308 is situated between the ground G and first node (corresponding to pin 344a). (The results of the analysis, set forth below, likely would yield even better optimization if accompanied by finite element analysis.)

With respect to y-direction forces at the pins and lands:

$${F}_{ncl} \approx 0$$

$${F}_{cl} = ( 0.5 ) {F}_{pin}$$

$${F}_{pin 2 - 5} = \frac{( 0.5 ) ma}{7}$$

$${F}_{pin 1} = ( 0.5 ) {F}_{pin 2 - 5}$$

in which F_{ncl} denotes the force at the non-contacting land 336a, F_{cl} denotes the force at the contacting land 336, Fₚᵢₙ denotes the force at a free-standing pin, Fₚᵢₙ₁ denotes the force at the pin 344a, and Fₚᵢₙ₂₋₅ denotes the force at pins 344b-344e. With respect to stiffness at pins and lands:

$${K}_{pin} = {N}_{pins / col} \times f ( {K}_{pin\_shear} , {K}_{pin\_bend} , {K}_{pin\_pivot} )$$

$${K}_{land} = \frac{{GL}_{y} {L}_{x}}{{L}_{z}}$$

$${K}_{web} = \frac{{GL}_{y} {L}_{z}}{{L}_{x}}$$

$${K}_{rigid} ⪢ {K}_{web}$$

wherein N_{pins/col} denotes number of free-standing pins per column, Kₚᵢₙ_{_{—}}ₛₕₑₐᵣ denotes pin-shear stiffness, Kₚᵢₙ_{_{—}}_{bend} denotes pin-bending stiffness, Kₚᵢₙ_{_{—}}ₚᵢᵥₒₜ denotes pin-pivoting stiffness, K_{land} denotes land stiffness, K_{web} denotes stiffness of the membrane (web) 328, and K_{rigid} denotes stiffness of the rigid element 308, G is shear modulus, Lₓ denotes length in the x-direction, L_{y} denotes length in the y-direction (scanning direction), and L_{z} denotes length in the z-direction.

As noted above, Kₚᵢₙ=N_{pins/col}×ƒ(Kₚᵢₙ_{_{—}}ₛₕₑₐᵣ, Kₚᵢₙ_{_{—}}_{bend}, Kₚᵢₙ_{_{—}}ₚᵢᵥₒₜ). Pin shear is diagrammed in FIG. 10(A), in which

$${Δ}_{1} = \frac{FH}{AG}$$

and Θ₁=0, wherein Δ₁ is displacement due to shear, F is force, H is pin height, A is pin cross-sectional area, and G is shear modulus of the pin. Pin bending from a force load is diagrammed in FIG. 10(B), in which

$${Δ}_{2} = \frac{{FH}^{3}}{3 EI} and {Θ}_{2} = \frac{{FL}^{2}}{2 EI} ,$$

wherein Δ₂ is displacement due to bending by a force load, L is pin length, E is the elastic (Young's) modulus of the pin, and I is the second moment of area of the pin. Pin bending from a moment load is diagrammed in FIG. 10(C), in which

$${Δ}_{3} = \frac{{ML}^{3}}{2 EI} and {Θ}_{3} = \frac{ML}{EI} ,$$

wherein Δ₃ is displacement dud to bending by a moment load, and M is moment. Pin pivoting is diagrammed in FIG. 10(D), in which

$$Δ = {Δ}_{1} + {Δ}_{2} + {Δ}_{3} + \frac{Θ t}{2} ,$$

wherein t is membrane thickness and

$$Θ = \frac{α M}{{Et}^{3}} = {θ}_{1} + {θ}_{2} + {θ}_{3} ,$$

wherein α≈61r⁶−192r⁵+246r⁴−168r³+68r²−18r+3 and r is the pin diameter/pin pitch. Hence,

$${K}_{pin} = {N}_{pins / col} \times {[ \frac{H}{AG} + \frac{{H}^{3}}{3 EI} + \frac{{tH}^{3}}{4 EI} - \frac{( H + t ) {H}^{3}}{4 EI ( \frac{I α}{{t}^{3}} + H )} ]}^{- 1} = \frac{F}{Δ}$$

(The alpha function generally was from Roark's Formulas for Stress and Strain, 7th Edition, Table 11.2, Case 20, page 493. The particular alpha expression provided above was a polynomial fit to the alpha function described in table form in the book.)

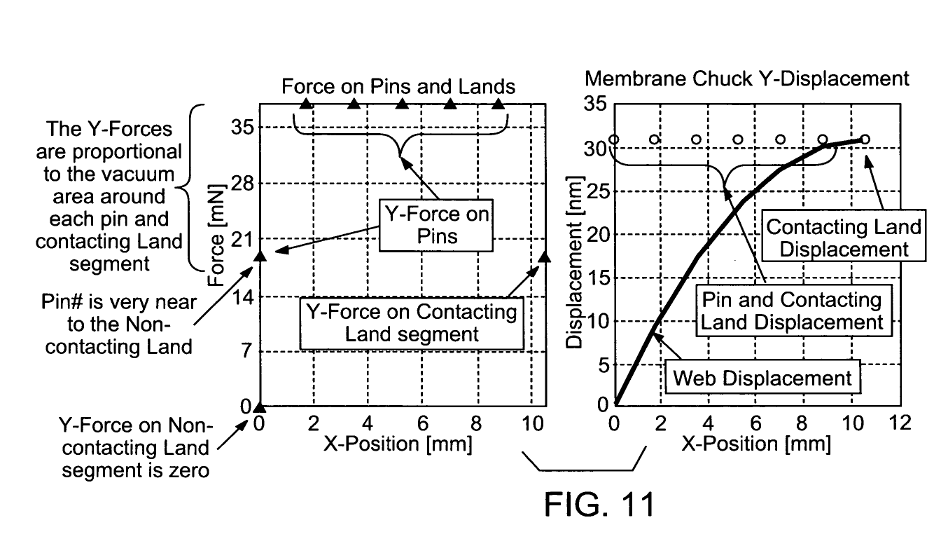

Plots of representative data are shown in FIG. 11, of which the left-hand plot is of force (N) versus x-position, and the right-hand plot is of displacement (nm) versus x-position. Turning first to the left-hand plot, note that the y-force on the non-contacting land 336a is zero. Also, since “pin #1” (i.e., pin 344a) is near the non-contacting land 336a, the y-direction force on that pin is lower than on the other pins 344b-344f (across the top of the plot). The y-direction force on the contacting land 336 is also lower than on the pins 344b-344f. With respect to the pins 344b-344f and contacting land 336, the y-direction forces are proportional to the vacuum area around each pin and contacting land. Turning to the right-hand plot, since the non-contacting land 336a does not contact the reticle 25, that land does not experience any displacement. Note that the pins 344a-344f and contacting land 336 (right-most circle) experience substantially equal displacement. The curve is of displacement of the membrane (web) 328.

### FOURTH REPRESENTATIVE EMBODIMENT

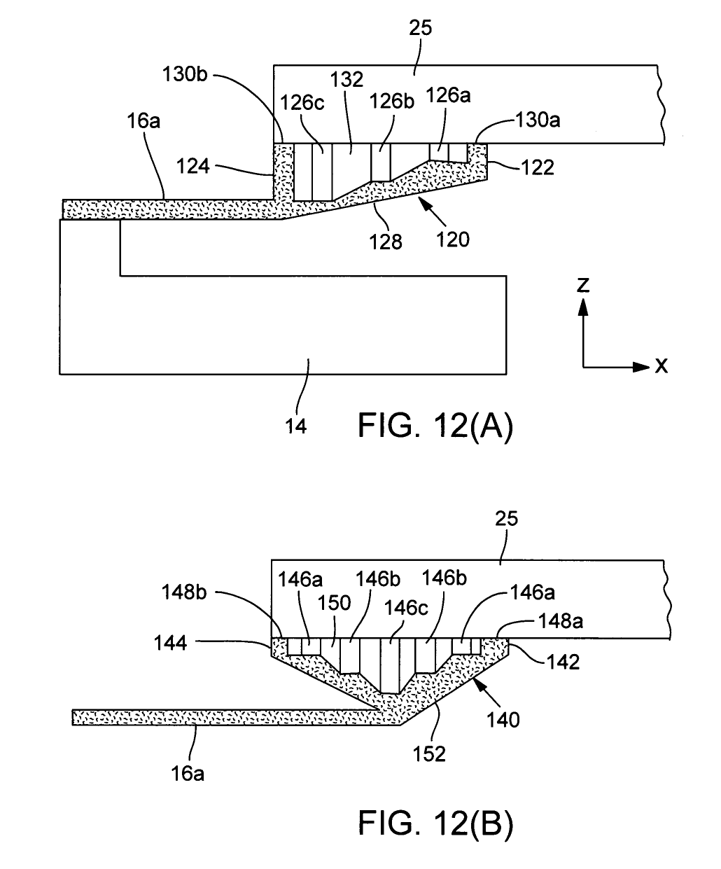

Various embodiments are configured so that the ratios of shear stresses to normal contact stresses are substantially equal at all points of contact of the reticle with the vacuum chucks. It alternatively is possible to distribute the shear stresses between the reticle and vacuum chucks so as to have the stresses vary from point to point in a desired manner. The instant embodiment is directed to achieving this variability by controllably varying the shear/bending stiffness of the pins. For example, changing the size (diameter and/or length) of the pins can produce corresponding changes in their shear/bending stiffness. Also, changing the thickness of the second membrane (web) beneath and around individual free-standing pins also can produce corresponding changes in their stiffness. Examples are shown in FIGS. 12(A) and 12(B). In FIG. 12(A) a portion of the reticle 25, the reticle-stage portion 14, and the first membrane 16a are shown, along with a vacuum chuck 120. The vacuum chuck 120 comprises shorter distal walls 122, taller proximal walls 124, and free-standing pins 126a, 126b, 126c extending upward from the surface of a stepped second membrane (web) 128. Note that the second membrane 128 can be simply an extension of the first membrane 16a. By way of example, the pins 126a, 126b, 126c vary in height from 0.25 to 2.5 mm. The reticle 25 rests not only on the tops of the pins 126a, 126b, 126c but also on lands 130a, 130b defined by the walls 122, 124, respectively. The lands 130a, 130b effectively enclose the region beneath the chucked portion of the reticle 25 to define a vacuum cavity 132.

In FIG. 12(B) depicts an alternative configuration in which the walls 142, 144 of a vacuum chuck 140 are shorter than the free-standing pins 146a, 146b, 146c. The walls 142, 144 provide lands 148a, 148b that effectively provide a vacuum “seal” to the under-surface of the reticle 25 to define a vacuum cavity 150. The base 152 is stepped to accommodate the different lengths of pins 146a-146c. Note also the variations in web thickness.

This representative embodiment can allow higher reticle acceleration, without reticle slip, by distributing the shear stresses between the reticle and the reticle chuck in a predetermined manner.

### FIFTH REPRESENTATIVE EMBODIMENT

In the first through fourth representative embodiments as described above, the walls of the vacuum chuck are integral with the second membrane (web) from which the walls extend upward in the z-direction. This is not intended to be limiting. As noted earlier above, the second membrane can be made of a first material, and at least one of the walls can be made of a second material, such as PTFE (TEFLON®) adhered to the surface from which the pins extend. (The free-standing pins most conveniently are made of the same material as, and are integral with, the surface.) By making a wall of a different material, the stiffness of the wall relative to the surface and/or relative to the pins can be further tailored for the particular situation in which the vacuum chucks will be used. An embodiment is depicted in FIG. 13, showing a vacuum chuck 422a comprising a first membrane 416a and a second membrane 428. (Actually, in this embodiment, the first membrane 416a and second membrane 428 are contiguous, wherein the second membrane 428 can be regarded as a portion of the first membrane 416a.) The vacuum chuck 422a also includes free-standing pins 444a-444c, an inboard wall 432 (providing inboard land 436), and an outboard wall 435 made of PTFE. The outboard wall 435 provides an outboard land 437. Note that the pins 444a-444c and inboard wall 432 in this embodiment extend upward from the surface 430. The reticle 25 rests on the lands 436, 437 and tops of the pins 444a-444c, thus defining a vacuum cavity 433. Evacuation of the vacuum cavity 433 urges the reticle 25 against the lands and tops of pins to hold the reticle on the vacuum chuck 422a. The outboard wall 435 is adhered to the surface 430 using a suitable adhesive.

It is also possible to tailor wall stiffness by changing the thickness (in the x- or y-dimension orthogonal to the length dimension) of the wall, as appropriate.

Lithography System

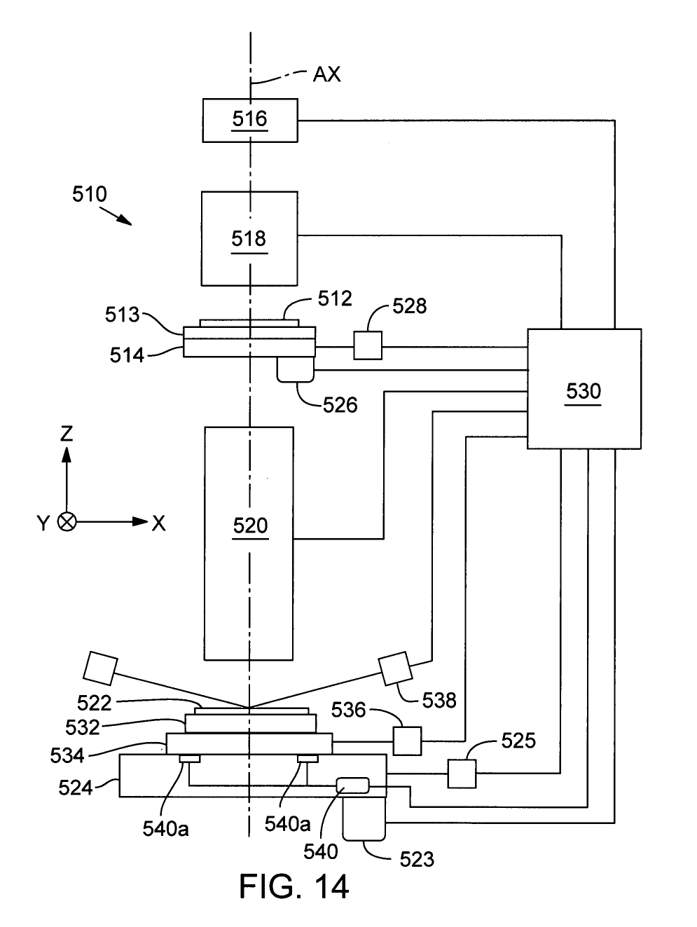

An exemplary microlithography system 510 (generally termed an “exposure system”) with which any of the foregoing embodiments can be used is depicted in FIG. 14, which depicts an example of a projection-exposure system. A pattern is defined on a reticle (sometimes termed a “mask”) 512 mounted on a reticle stage 514. The reticle stage 514 can be configured as any of the embodiments described above. The reticle 512 is “illuminated” by an energy beam (e.g., DUV light) produced by a source 516 and passed through an illumination-optical system 518. As the energy beam passes through the reticle 512, the beam acquires an ability to form an image, of the illuminated portion of the reticle 512, downstream of the reticle. The beam passes through a projection-optical system 520 that focuses the beam on a sensitive surface of a substrate 522 held on a substrate stage (“wafer stage” or “wafer XY stage”) 524. As shown in the figure, the source 516, illumination-optical system 518, reticle stage 514, projection-optical system 520, and wafer stage 524 generally are situated relative to each other along an optical axis AX. The reticle stage 514 is movable at least in the x- and θ_{z}-directions using a stage actuator 526 (e.g., linear motor), and the positions of the reticle stage 514 in the x- and y-directions are detected by respective interferometers 528. The system 510 is controlled by a controller (computer) 530.

The substrate 522 (also termed a “wafer”) is mounted on the wafer stage 524 by a wafer chuck 532 and wafer table 534 (also termed a “leveling table”). The wafer stage 524 not only holds the wafer 522 for exposure (with the resist facing in the upstream direction) but also provides for controlled movements of the wafer 522 in the x- and y-directions as required for exposure and for alignment purposes. The wafer stage 524 is movable by a suitable wafer-stage actuator 523 (e.g., linear motor), and positions of the wafer stage 524 in the X- and Y-directions are determined by respective interferometers 525. The wafer table 534 is used to perform fine positional adjustments of the wafer chuck 532 (holding the wafer 522), relative to the wafer stage 524, in each of the x-, y-, and z-directions. Positions of the wafer table 534 in the x- and y-directions are determined by respective wafer-stage interferometers 536.

The wafer chuck 532 is configured to hold the wafer 522 firmly for exposure and to facilitate presentation of a planar sensitive surface of the wafer 522 for exposure. The wafer 522 usually is held to the surface of the wafer chuck 532 by vacuum, although other techniques such as electrostatic attraction can be employed under certain conditions. The wafer chuck 532 also facilitates the conduction of heat away from the wafer 522 that otherwise would accumulate in the wafer during exposure.

Movements of the wafer table 534 in the z-direction (optical-axis direction) and tilts of the wafer table 34 relative to the z-axis (optical axis AX) typically are made in order to establish or restore proper focus of the image, formed by the projection-optical system 520, on the sensitive surface of the wafer 522. “Focus” relates to the position of the exposed portion of the wafer 522 relative to the projection-optical system 520. Focus usually is determined automatically, using an auto-focus (AF) device 538. The AF device 538 produces data that is routed to the controller 530. If the focus data produced by the AF device 538 indicates existence of an out-of-focus condition, then the controller 530 produces a “leveling command” that is routed to a wafer-table controller 540 connected to individual wafer-table actuators 540a. Energization of the wafer-table actuators 540a results in movement and/or tilting of the wafer table 534 serving to restore proper focus.

The exposure system 5 10 can be any of various types. For example, as an alternative to operating in a “step-and-repeat” manner characteristic of steppers, the exposure system can be a scanning-type apparatus operable to expose the pattern from the reticle 512 to the wafer 522 while continuously scanning both the reticle 512 and wafer 522 in a synchronous manner. During such scanning, the reticle 512 and wafer 522 are moved synchronously in opposite directions perpendicular to the optical axis Ax. The scanning motions are performed by the respective stages 514, 524.

In contrast, a step-and-repeat exposure apparatus performs exposure only while the reticle 512 and wafer 522 are stationary. If the exposure apparatus is an “optical lithography” apparatus, the wafer 522 typically is in a constant position relative to the reticle 512 and projection-optical system 520 during exposure of a given pattern field. After the particular pattern field is exposed, the wafer 522 is moved, perpendicularly to the optical axis AX and relative to the reticle 512, to place the next field of the wafer 522 into position for exposure. In such a manner, images of the reticle pattern are sequentially exposed onto respective fields on the wafer 522.

Exposure systems as provided herein are not limited to microlithography systems for manufacturing microelectronic devices. As a first alternative, for example, the exposure system can be a microlithography system used for transferring a pattern for a liquid-crystal display (LCD) onto a glass plate. As a second alternative, the exposure system can be a microlithography system used for manufacturing thin-film magnetic heads. As a third alternative, the exposure system can be a proximity-microlithography system used for exposing, for example, a mask pattern. In this alternative, the mask and substrate are placed in close proximity with each other, and exposure is performed without having to use a projection-optical system 520.

The principles set forth in the foregoing disclosure further alternatively can be used with any of various other apparatus, including (but not limited to) other microelectronic-processing apparatus, machine tools, metal-cutting equipment, and inspection apparatus.

In any of various exposure systems as described above, the source 516 (in the illumination-optical system 518) of illumination “light” can be, for example, a g-line source (436 nm), an i-line source (365 nm), a KrF excimer laser (248 nm), an ArF excimer laser (193 nm), or an F₂ excimer laser (157 nm). Alternatively, the source 516 can be of any other suitable exposure light.

With respect to the projection-optical system 520, if the illumination light comprises far-ultraviolet radiation, then the constituent lenses are made of UV-transmissive materials such as quartz and fluorite that readily transmit ultraviolet radiation. If the illumination light is produced by an F₂ excimer laser or EUV source, then the tenses of the projection-optical system 520 can be either refractive or catadioptric, and the reticle 512 desirably is a reflective type. If the illumination light is in the vacuum ultraviolet (VUV) range (less than 200 nm), then the projection-optical system 520 can have a catadioptric configuration with beam splitter and concave mirror, as disclosed for example in U.S. Pat. Nos. 5,668,672 and 5,835,275, incorporated herein by reference. The projection-optical system 520 also can have a reflecting-refracting configuration including a concave mirror but not a beam splitter, as disclosed in U.S. Pat. Nos. 5,689,377 and 5,892,117, incorporated herein by reference.

Either or both the reticle stage 514 and wafer stage 524 can include respective linear motors for achieving the motions of the reticle 512 and wafer 522, respectively, in the x-axis and y-axis directions. The linear motors can be air-levitation types (employing air bearings) or magnetic-levitation types (employing bearings based on the Lorentz force or a reactance force). Either or both stages 514, 524 can be configured to move along a respective guide or alternatively can be guideless. See U.S. Pat. Nos. 5,623,853 and 5,528,118, incorporated herein by reference.

Further alternatively, either or both stages 514, 524 can be driven by a planar motor that drives the respective stage by electromagnetic force generated by a magnet unit having two-dimensionally arranged magnets and an armature-coil unit having two-dimensionally arranged coils in facing positions. With such a drive system, either the magnet unit or the armature-coil unit is connected to the respective stage and the other unit is mounted on a moving-plane side of the respective stage.

Movement of a stage 514, 524 as described herein can generate reaction forces that can affect the performance of the exposure apparatus. Reaction forces generated by motion of the wafer stage 524 can be shunted to the floor (ground) using a frame member as described, e.g., in U.S. Pat. No. 5,528,118, incorporated herein by reference. Reaction forces generated by motion of the reticle stage 514 can be shunted to the floor (ground) using a frame member as described in U.S. Pat. No. 5,874,820, incorporated herein by reference.

An exposure system such as any of the various types described above can be constructed by assembling together the various subsystems, including any of the elements listed in the appended claims, in a manner ensuring that the prescribed mechanical accuracy, electrical accuracy, and optical accuracy are obtained and maintained. For example, to maintain the various accuracy specifications, before and after assembly, optical-system components and assemblies are adjusted as required to achieve maximal optical accuracy. Similarly, mechanical and electrical systems are adjusted as required to achieve maximal respective accuracies. Assembling the various subsystems into an exposure apparatus requires the making of mechanical interfaces, electrical-circuit wiring connections, and pneumatic plumbing connections as required between the various subsystems. Typically, constituent subsystems are assembled prior to assembling the subsystems into an exposure apparatus. After assembly of the apparatus, system adjustments are made as required for achieving overall system specifications in accuracy, etc. Assembly at the subsystem and system levels desirably is performed in a clean room where temperature and humidity are controlled.

Semiconductor-Device Fabrication

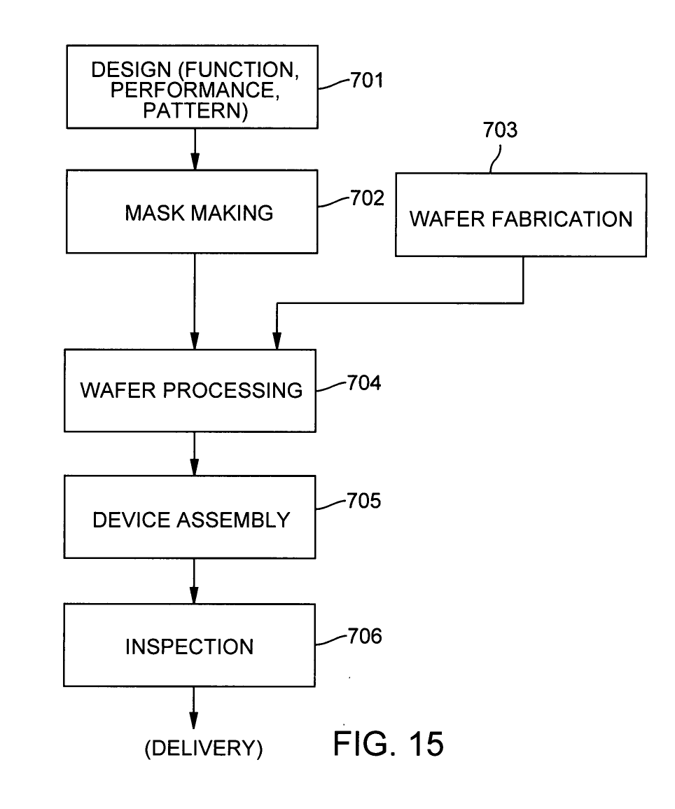

Semiconductor devices can be fabricated by processes including microlithography steps performed using a microlithography system as described above. Referring to FIG. 15, in step 701 the function and performance characteristics of the semiconductor device are designed. In step 702 a reticle defining the desired pattern is designed according to the previous design step. Meanwhile, in step 703, a substrate (wafer) is made and coated with a suitable resist. In step 704 the reticle pattern designed in step 702 is exposed onto the surface of the substrate using the microlithography system. In step 705 the semiconductor device is assembled (including “dicing” by which individual devices or “chips” are cut from the wafer, “bonding” by which wires are bonded to the particular locations on the chips, and “packaging” by which the devices are enclosed in appropriate packages for use). In step 706 the assembled devices are tested and inspected.

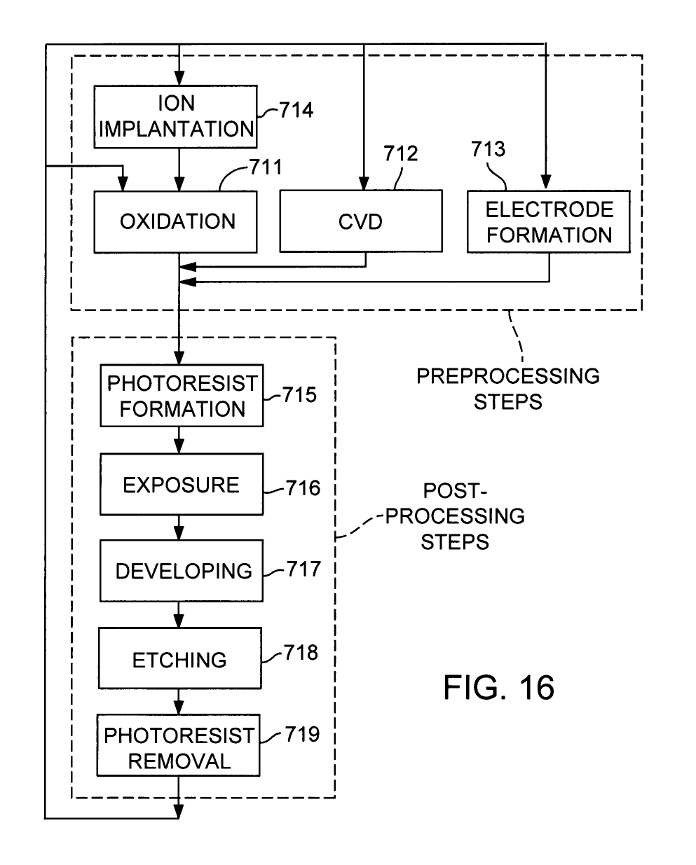

Representative details of a wafer-processing process including a microlithography step are shown in FIG. 16. In step 711 (oxidation) the wafer surface is oxidized. In step 712 (CVD) an insulative layer is formed on the wafer surface. In step 713 (electrode formation) electrodes are formed on the wafer surface by vapor deposition for example. In step 714 (ion implantation) ions are implanted in the wafer surface. These steps 711-714 constitute representative “pre-processing” steps for wafers, and selections are made at each step according to processing requirements.

At each stage of wafer processing, when the pre-processing steps have been completed, the following “post-processing” steps are implemented. A first post-process step is step 715 (photoresist formation) in which a suitable resist is applied to the surface of the wafer. Next, in step 716 (exposure), the microlithography system described above is used for lithographically transferring a pattern from the reticle to the resist layer on the wafer. In step 717 (development) the exposed resist on the wafer is developed to form a usable mask pattern, corresponding to the resist pattern, in the resist on the wafer. In step 718 (etching), regions not covered by developed resist (i.e., exposed material surfaces) are etched away to a controlled depth. In step 719 (photoresist removal), residual developed resist is removed (“stripped”) from the wafer.

Formation of multiple interconnected layers of circuit patterns on the wafer is achieved by repeating the pre-processing and post-processing steps as required. Generally, a set of pre-processing and post-processing steps are conducted to form each layer.

Whereas the disclosure was set forth in the context of various representative embodiments, it will be understood that the scope of the invention is not limited to those embodiments. On the contrary, the invention is intended to encompass all modifications, alternatives, and equivalents falling within the spirit and scope of the invention, as defined by the appended claims.

What is claimed is:

1. A device for holding and moving a planar body, the device comprising:
a stage having a movable support surface;
a body chuck;
a first membrane including a proximal region and a distal region, the proximal region being coupled to the support surface and the distal region extending from the support surface and being coupled to the body chuck such that the first membrane at least partially supports the body chuck;
the body chuck comprising a surface and multiple pins extending relative to the surface and being arrayed on the surface to contact and support a respective portion of the body relative to the surface and distal region; and
the pins being arrayed so that, during movements of the body chuck imparted by corresponding movement of the support surface, slippage of the body relative to the pins due to forces caused by the movement is substantially uniform at each pin.

2. The device of claim 1, wherein the body chuck comprises at least one vacuum chuck.

3. The device of claim 1, wherein the body chuck comprises walls extending from the surface, the walls defining, in cooperation with the surface and a portion of the body contacting the body chuck, a vacuum cavity.

4. The device of claim 3, wherein the pins include side pins located in the vacuum cavity and associated with the walls and free-standing pins situated in the vacuum cavity and extending from the surface.

5. The device of claim 3, wherein:
the walls have respective lands;
the pins have respective top surfaces; and
at least the top surfaces of the pins collectively define a chuck surface that contacts and at least partially supports the body whenever the body is being held by the device.

6. The device of claim 5, wherein at least one of the lands, along with the top surfaces, collectively define a chuck surface that contacts and at least partially supports the body whenever the body is being held by the device.

7. The device of claim 5, wherein the top surfaces contact an under-surface of the body.

8. The device of claim 5, wherein the top surfaces and at least one land contact an under-surface of the body.

9. The device of claim 3, wherein at least one of the walls is made of a different material than the first membrane and is mounted to the surface.

10. The device of claim 1, wherein the pins are arranged to extend in at least one longitudinal column in a scanning direction of the body chuck as moved by the support surface.

11. The device of claim 10, wherein the pins are arranged at substantially identical pitch in the at least one column.

12. The device of claim 10, wherein the pins are arranged in multiple longitudinal columns.

13. The device of claim 12, wherein:
each column has a respective pin-pitch; and
the respective pin-pitches are substantially identical.

14. The device of claim 13, wherein:
each column has a respective pin-pitch; and
the respective pin-pitches of at least two columns are different.

15. The device of claim 12, wherein the columns are substantially equally spaced from each other.

16. The device of claim 12, wherein the columns are differently spaced from each other.

17. The device of claim 1, wherein the pins are shaped identically.

18. The device of claim 1, wherein the pins have at least two different shapes.

19. The device of claim 1, wherein the pins have substantially identical respective stiffness.

20. The device of claim 1, wherein the pins have variable stiffness.

21. The device of claim 1, wherein the first membrane has a substantially uniform thickness.

22. The device of claim 1, wherein the first membrane has a variable thickness.

23. The device of claim 1, wherein:
the body chuck further comprises a second membrane comprising the surface relative to which the pins extend;
the second membrane is coupled to the distal region; and
the pins contact and support the respective portion of the body relative to the second membrane.

24. The device of claim 23, wherein:
the stage has a first and a second support surfaces spaced apart from each other;
the body chuck comprises a first chuck portion and a second chuck portion;
the first membrane comprises a first membrane portion mounted to and extending from the first support surface and a second membrane portion mounted to and extending from the second support surface;
the first chuck portion is mounted to a distal region of the first membrane portion; and
the second chuck portion is mounted to a distal region of the second membrane portion.

25. The device of claim 23, wherein the body chuck comprises at least one vacuum chuck.

26. The device of claim 23, wherein the body chuck comprises walls extending from the second membrane, the walls defining, in cooperation with the second membrane and a portion of the body contacting the body chuck, a vacuum cavity.

27. The device of claim 26, wherein:
the walls have respective lands;
the pins have respective top surfaces; and
at least the top surfaces of the pins collectively define a chuck surface that contacts and at least partially supports the body whenever the body is being held by the device.

28. The device of claim 27, wherein the top surfaces and at least one of the lands collectively define the chuck surface.

29. The device of claim 27, wherein at least the top surfaces contact an under-surface of the body.

30. The device of claim 28, wherein the top surfaces and at least one of the lands contact an under-surface of the body.

31. The device of claim 26, wherein the walls are integral with the second membrane.

32. The device of claim 26, wherein at least one of the walls is made of a different material than the second membrane and is mounted to the second membrane.

33. The device of claim 23, wherein the pins are arranged to extend in at least one longitudinal column in a scanning direction of the body chuck as moved by the support surface.

34. The device of claim 33, wherein the pins are arranged at substantially identical pitch in the at least one column.

35. The device of claim 33, wherein the pins are arranged in multiple longitudinal columns.

36. The device of claim 35, wherein:
each column has a respective pin-pitch; and
the respective pin-pitches are substantially identical.

37. The device of claim 36, wherein:
each column has a respective pin-pitch; and
the respective pin-pitches of at least two columns are different.

38. The device of claim 35, wherein the columns are substantially equally spaced from each other.

39. The device of claim 35, wherein the columns are differently spaced from each other.

40. The device of claim 23, wherein the pins are shaped identically.

41. The device of claim 23, wherein the pins have respective shapes selected from the group consisting of cylindrical, spherical, rectangular, elliptical, oval, square, other polygonal, frustoconical, stepped, and combinations thereof.

42. The device of claim 23, wherein the pins have substantially identical respective stiffness.

43. The device of claim 23, wherein the pins have variable stiffness.

44. The device of claim 23, wherein the second membrane has a substantially uniform thickness.

45. The device of claim 23, wherein the second membrane has a variable thickness.

46. The device of claim 23, wherein the second membrane is made of a material selected from the group consisting of fused silica, calcium fluoride, magnesium fluoride, barium fluoride, cordierite (magnesium aluminum silicate), aluminum oxide, invar, ZERODUR®, and stainless steel.

47. The device of claim 23, wherein the pins are integral with, and made of the material as, the second membrane.

48. The device of claim 23, wherein at least one of the walls is made of the same material as the second membrane.

49. The device of claim 23, wherein at least one of the walls is made of a different material than the second membrane and is attached to the second membrane.

50. The device of claim 49, wherein the at least one wall is made of a material selected from the group consisting of PTFE and low-durometer, chemically clean rubber.

51. A device for holding and moving a reticle, the device comprising:
a stage comprising first and second movable support surfaces; and
a reticle chuck mounted to the support surfaces, the reticle chuck comprising first and second chuck portions, each chuck portion comprising a respective first membrane having a respective first region and a respective second region;
the first regions being mounted to the respective first and second support surfaces such that the second regions extend toward each other from the first and second support surfaces;
the first and second chuck portions being mounted to the respective second regions;
each chuck portion comprising respective walls and free-standing pins extending from a respective surface, the surface and walls collectively defining a respective vacuum cavity whenever a respective region of a reticle is situated on the chuck portion;
in each chuck portion, at least the pins contacting and supporting the respective region of the reticle; and
the pins being configured and arranged so that, during a movement of the reticle chuck by the stage, slippage of the reticle relative to the pins due to shear forces caused by the movement occurs with substantial uniformity at each pin.

52. The device of claim 51, wherein the free-standing pins are arranged in multiple columns on the surface in each chuck portion.

53. The device of claim 52, wherein:
each column has a respective pin-pitch; and
the respective pin-pitches are substantially identical.

54. The device of claim 52, wherein:
each column has a respective pin-pitch; and
the respective pin-pitches of at least two columns are different.

55. The device of claim 52, wherein the free-standing pins have a constant pitch in at least one column.

56. The device of claim 52, wherein the respective pin-pitch in at least one column is variable.

57. The device of claim 51, wherein at least one wall of each chuck portion provides a contacting land.

58. The device of claim 57, wherein the at least one contacting land and tops of the pins in each chuck portion collectively define respective chuck surfaces situated in a plane and configured to hold respective portions of the reticle.

59. The device of claim 51, wherein at least one wall is made of a different material than the respective surface and is mounted to the respective surface.

60. The device of claim 51, wherein the columns in at least one chuck portion are substantially equally spaced from each other.

61. The device of claim 51, wherein the columns in at least one chuck portion are differently spaced from each other.

62. The device of claim 51, wherein the pins in at least one chuck portion are shaped substantially identically.

63. The device of claim 51, wherein the pins have substantially identical respective stiffness.

64. The device of claim 51, wherein at least some of the pins have variable stiffness.

65. The device of claim 51, wherein the first membranes have substantially uniform thickness.

66. The device of claim 51, wherein the first membranes have variable thickness.

67. The device of claim 51, wherein each chuck portion comprises a respective second membrane comprising the respective surface.

68. The device of claim 67, wherein the second membranes have substantially uniform thickness.

69. The device of claim 67, wherein the second membranes have variable thickness.

70. A process system, comprising:
a process device; and
a device, as recited in claim 1, for holding and moving a planar body relative to the process device.

71. The system of claim 70, wherein the process device comprises an optical system.

72. A microlithography system, comprising:
an imaging optical system configured to imprint a pattern, defined on a reticle, on a lithographic substrate;
a reticle stage situated relative to the imaging optical system and comprising a movable support surface; and
a reticle chuck mounted to the support surface, the reticle chuck comprising at least one chuck portion;
the chuck portion comprising a first membrane including a proximal region and a distal region, the proximal region being coupled to the support surface and the distal region extending from the support surface and being coupled to the chuck portion such that the first membrane at least partially supports the reticle chuck;
the chuck portion comprising a surface and multiple pins extending from the surface, the surface being situated at the distal region of the first membrane, the pins being arrayed on the surface to contact and support a respective portion of the reticle relative to the surface; and
the pins being arrayed so that, during movements of the reticle chuck imparted by corresponding movement of the support surface, slippage of the reticle relative to the pins due to forces caused by the movement is substantially uniform at each pin.

73. The microlithography system of claim 72, wherein the imaging optical system is configured to utilize ultraviolet light as an exposure light.

74. A microelectronic device, fabricated by a process including at least one microlithography step performed with a microlithography system as recited in claim 72.

75. A microlithography process, performed using a microlithography system as recited in claim 72.

76. A microlithography system, comprising:
an imaging optical system configured to imprint a pattern, defined on a reticle, on a lithographic substrate;
a reticle stage situated relative to the imaging optical system and comprising first and second movable support surfaces; and
a reticle chuck mounted to the support surfaces and comprising first and second chuck portions, each chuck portion comprising a respective first membrane having a respective first region and a respective second region;
the first regions being mounted to the respective first and second support surfaces such that the second regions extend toward each other from the first and second support surfaces;
the first and second chuck portions being mounted to the respective second regions;
each chuck portion comprising a respective surface and respective walls and free-standing pins extending from the surface, the surface and respective walls collectively defining a respective vacuum cavity whenever a respective region of a reticle is situated on the chuck portion;
at least the pins being configured to contact and support the respective region of the reticle; and
the pins being configured and arranged so that, during a movement of the reticle chuck by the stage, slippage of the reticle relative to the pins due to shear forces caused by the movement occurs with substantial uniformity at each pin.

77. The microlithography system of claim 76, wherein the imaging optical system is configured to utilize ultraviolet light as an exposure light.

78. A microelectronic device, fabricated by a process including at least one microlithography step performed with a microlithography system as recited in claim 76.

79. A microlithography process, performed using a microlithography system as recited in claim 76.
